(19) United States
(12) Patent Application Publication
(10) Pub. No.: US 2012/0138559 A1
(43) Pub. Date: Jun. 7, 2012

(54) MODULAR LOAD BEARING DEVICE INCLUDING COMPOSITE COMPONENTS

(76) Inventors: Scott L. Huff, Shenzhen (CN); Stefan Berger, Shenzhen (CN); Junfeng Wang, Beijing (CN); Song Lin, Beijing (CN); Han Lin, Shenzhen (CN)

(21) Appl. No.: 13/294,396

(22) Filed: Nov. 11, 2011

Related U.S. Application Data
(63) Continuation-in-part of application No. 12/014,299, filed on Jan. 15, 2008, now abandoned.

(51) Int. Cl. B66C 19/00; B66D 1/36

(52) U.S. Cl. 212/175; 254/266

(57) ABSTRACT

A modular structural load bearing device including light-weight composite structural members each including an elongated body having at least one internal recess for a cable in the recess or series of recesses. Preassembled and presized composite support members and connectors can form a modular structure, such as a crane. When used, end pieces or other components on an end of the elongated body can secure a cable. For assembly of the structural load bearing apparatus, connectors can be used with composite structural members that are light-weight with relatively thin walls while providing enhanced benefits for resisting the combination of tension, compression and buckling forces.

### CROSS REFERENCE TO RELATED APPLICATION

This application is a continuation-in-part of U.S. patent application Ser. No. 12/014,299, filed Jan. 15, 2008.

### BACKGROUND

This disclosure relates to a modular structural load bearing device, such as a gantry crane, including structural members preconstructed for strength in tension and compression. More specifically, the structural load bearing device includes structural members as components with a body with composite fibers with an access for an internal cable.

Load bearing structural members often have elongated bodies, and must be light-weight for certain construction projects. Applications include structures that must be constructed by hand, such as in remote or military applications, such as for cranes assembled on oil rigs. As such, certain structural members must not be heavy while still being able to handle appropriate loads and forces.

Cranes are known, such as gantry cranes that lift objects by a hoist that is fitted in a hoist trolley and can move horizontally on wheels or rails fitted under a beam. A gantry crane or portal crane has a similar mechanism supported by uprights, usually with wheels at the foot of the uprights allowing the crane to traverse. The gantry crane frame can be supported on a gantry system with equalized beams and wheels that run on the gantry track, usually perpendicular to the trolley travel direction. Some portal cranes may have only a fixed gantry, particularly when they are lifting loads such as ship cargoes that are already easily moved beneath them.

Aluminum extrusion pieces, such as shown in U.S. Pat. No. 6,561,571, have been used for structural members requiring strength in compression and axial forces. Aluminum is known to form many hard, light and corrosion-resistant alloys for use as structural members.

Also, U.S. Pat. No. 6,539,679 discloses a light-weight structural member with a strength-reinforcing flat steel strap. The steel strap extends along the length of the structural body, and it transfers load outwardly toward the opposing portions of the structural body. Anchor plates at opposing ends of the structural body hold the strap in tension. The pre-tensioned strap is secured in tension to opposing ends.

Next, various cables have previously been used in tension, but not in the same structural member arrangement of the present disclosure.

### SUMMARY

The present disclosure provides a structural load bearing device, such as a crane, including components as light-weight composite structural members that can form a modular structure of assembleable presized components. The composite structural member is light-weight while providing enhanced benefits for resisting a combination of tension, compression, and buckling forces.

A composite structural member includes an elongated body having one or more internal recesses for a cable in one recess or a series of recesses. The cable may be pretensioned in a preassembled component or may be suitable for a safety rope of the entire structural load bearing device. End pieces on each end of the elongated body can secure the internal cable to the body. Each end piece may include an aperture and adjustable means to secure the cable in tension. The cable may also provide an additional safety factor for the structural member and the entire crane.

### BRIEF DESCRIPTION OF THE DRAWINGS

The above-mentioned and other features of this disclosure and the manner of obtaining them will become more apparent, and the disclosure itself will be best understood by reference to the following descriptions of structural members and devices taken in conjunction with the accompanying figures, which are given as non-limiting examples only, in which:

FIG. 1 shows a perspective view of a composite structural member;

FIG. 2 shows an end and shortened length view of the structural member;

FIG. 3 shows a cross sectional view of the member of FIG. 2;

FIG. 4 shows a partially cut away view of an end of the structural member;

FIG. 5 shows a perspective exploded view of a structural member having a single internal cable;

FIG. 6 shows a view of an end of the single-cable structural member;

FIG. 7 shows a cross sectional view of an end of the structural member;

FIG. 8 shows a top view of a composite structural member;

FIG. 9 show a cross sectional view of FIG. 8 taken along A-A;

FIG. 10 shows an exploded view of the composite structural member of FIG. 8 with interconnecting connectors and preloaded cable:

FIG. 10A shows a detail of the connectors and cable from “B” of FIG. 10;

FIG. 11 shows a perspective view of a crane including composite structural members;

FIG. 12 shows an end view of a crane; and

FIG. 13 shows a cross sectional view of the crane of FIG. 12 taken along section line A-A.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiments in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the following description or illustrated in the figures.

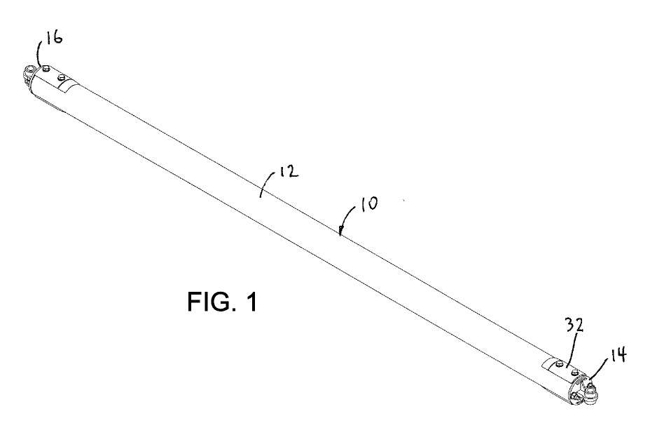

As shown in FIG. 1, a composite structural member 10 includes an elongated body 12, end pieces 14 and 16 located at first and second ends of the elongated body 12, and one or more internal tension members, such as cables 18 that can be connected in tension to the end pieces 14 and 16. The elongated body 12 includes a generally linear central longitudinal axis and at least one internal recess 20 that can accommodate the cable 18. Various complementary components combine to produce structural and functional properties not present in any individual component.

The elongated body 12 can be preloaded to resist compression or lateral forces. The elongated body 12 preferably includes internal walls 22 for added reinforcement and strength. As shown in the drawings, certain internal walls 22 can be perpendicular to the outer surface 24 of the elongated body 12. Additional internal walls 26 can be concentric with or parallel to the outer surface 24 of the elongated body 12.

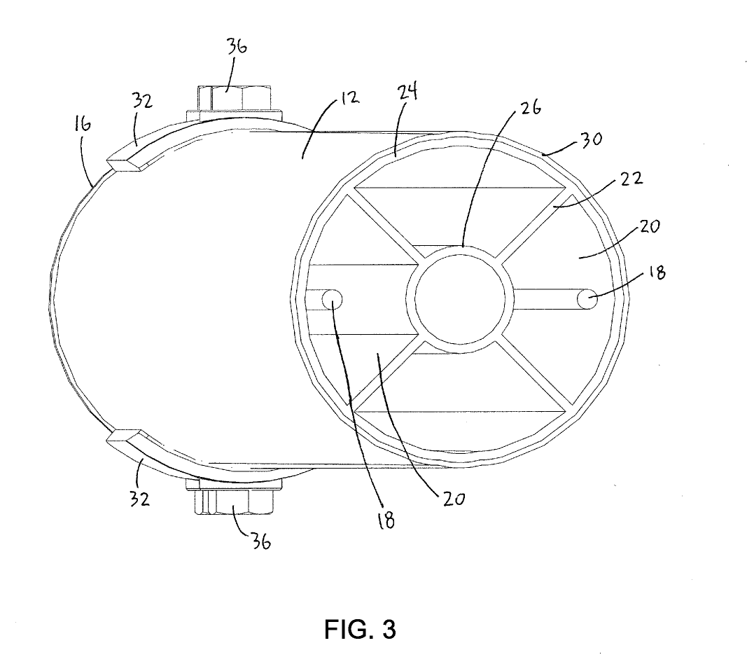

The elongated body 12 preferably has a plurality of internal recesses 20 extending from the first end to the second end of the body 12 and that are capable of enclosing a plurality of internal cables 18. As shown in FIG. 3, the elongated body 12 includes two cables 18 in opposite internal recesses 20 that are formed between internal walls 22, the outer surface 24 of the elongated body 12, and additional internal walls 26.

The elongated body 12 is preferably preloaded extruded aluminum with a cover mantle 30, such as carbon fiber, S glass fiber, a thin swaged layer of steel or Kevlar, on the outer surface 24. The cover mantle 30 can additionally assist with resisting forces of compression and buckling.

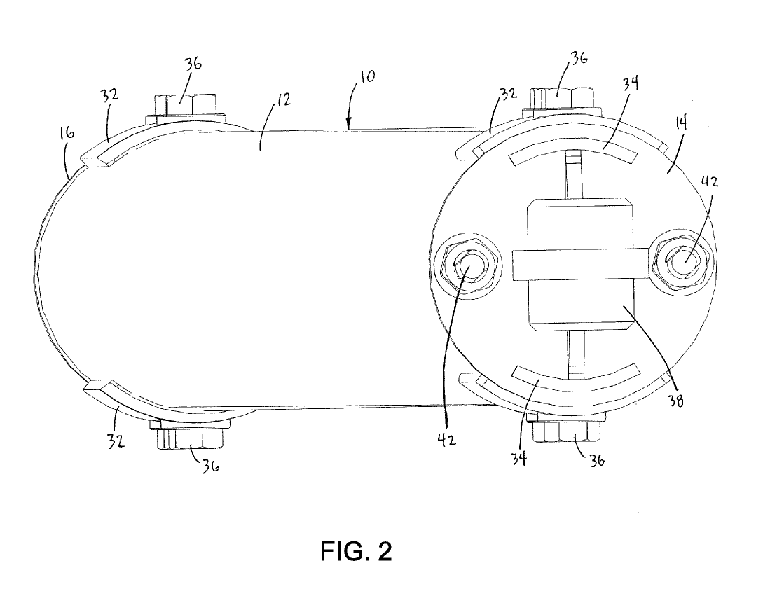

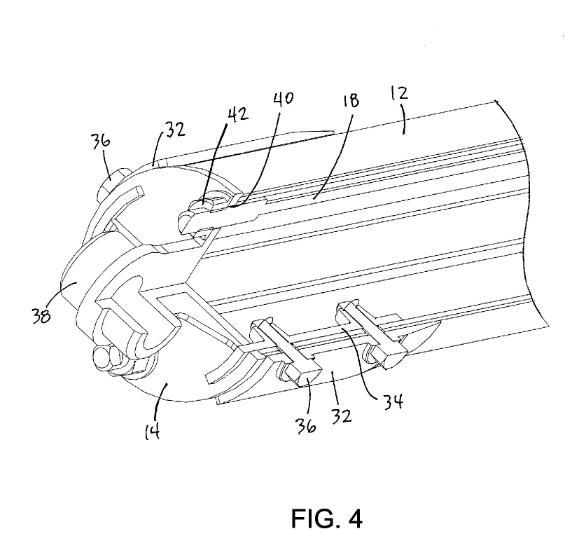

The end pieces 14 and 16 are preferably end caps that preferably completely cover each end of the elongated body 12. The end pieces 14 and 16 can be respectively secured to each end of the elongated body 12 by a variety of means, including welding, friction fit, cable tension or fastening plates 32. As shown in FIGS. 1-4, particularly FIG. 4, the fastening plate 32 can be secured to an end of the elongated body 12 and to an internal head plate 34 by fasteners 36, such as bolts. As shown in FIGS. 2 and 4, the head plate 34 can pass through an aperture or slot in the end piece 14.

As such, the end pieces 14 and 16 are respectively connected on each end of the elongated body 12 by fastening plates 32 fastened to head plates 34 that pass through each end piece 14 and 16. An end portion of the elongated body 12 is secured between the fastening plates 32 and the head plates 34. Preferably, the fastening plates 32 and head plates 34 are friction fit with the elongated body 12 and secured, such as by a fastener 36. The fastening plates 32 and head plates 34 may be clamped and loaded together on a portion of the elongated body 12 so hard that they should not move under normal load. The head plate 34 passing through the end piece 14 and 16 transfers force on the end pieces 14 and 16 to the outer wall 24 of the elongated body 12 and prevents rotation of the head plate 34 and/or end pieces 14 and 16 with respect to the body 12.

The end pieces 14 and 16 preferably cover each end of the elongated body 12 and may include a functional piece 38, such as a socket, collar or pin holder for use in making a connection with another structure. The end pieces 14 and 16 may have an aperture 40 capable of serving as a cable hole through which each end of the cable 18 are connected to each end piece 14 and 16. Preferably, at least one cable aperture 40 includes a means for preloading the cable with tension 42, such as including an incised threaded rod, i.e. a helically advancing threaded screw and washer. The means for preloading the cable 42 includes various screws and washers. A cable head 44 may be included that is secured to an end of the cable 18 as part of the means for preloading the cable 42. Other means to fasten and preload the cable include the cable being threaded on a small pulley with a rack and pawl to load the cable 18 and keep it from unwinding.

The cable 18 is connected to each end piece 14 and 16 and can be adjusted as a pretensioned cable fitted between the end caps 14 and 16. The cable 18 can be stretched under pretension and affixed to end caps 14 and 16 at both ends of the structural member 10, passing inside the internal recess 20.

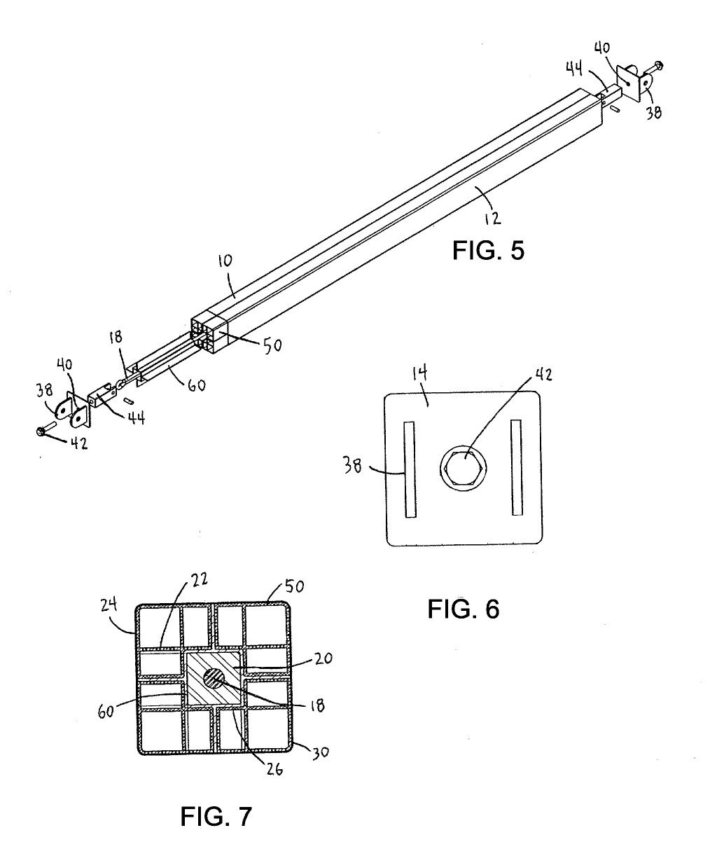

In another embodiment shown in FIGS. 5-7, L-shaped extruded aluminum pieces 50 can be assembled to form a long square elongated body 12, such as a strut or brace. The series of hollow L-shaped pieces 50 are assembled to form a long square member. The L-shaped pieces 50 can have at least one internal wall 22 for added reinforcement. The pieces 50 are assembled with a single internal recess 20 for the tensioned cable 18 fitted between end caps 14 and 16 with an aperture 40 capable of serving as a cable aperture through which each end of the cable 18 is connected to each end piece 14 and 16. With the cable aperture 40, a means for preloading the cable with tension 42, such as a screw, can be used. A cable head 44 secured to an end of the cable 18 is shown in FIG. 5. As detailed above, the cable 18 is preferably stretched under pretension and affixed to end pieces 14 and 16 at both ends of the composite structural member 10.

Per the example shown in FIGS. 5-7, four pieces 50 (preferably extruded aluminum) are light and thin walled. Each extruded piece 50 is reinforced hollow “L” shaped in the cross-section with internal and external vertexes. These pieces 50 collectively form a square and help resist against buckling. It is possible that these four pieces 50 could be inside another square structure or wrapped or otherwise secured together by a cover mantle 30, such as tape (spiral or cigarette wrapped), carbon fiber layers, a thin swaged layer of steel, or a Kevlar coating.

In the center of the four pieces 50, an insert 60 can be wedged as shown in FIGS. 5 and 7, in which the cable 18 can also pass to handle tension. The insert 60, preferably steel, can be wedged in the center of the four pieces 50. The insert 60 has a base structure, preferably a hollow square, with protrusions extending from four sides (somewhat like a plus symbol in cross section), which each extend between two adjacent extruded pieces 50. A wedge insert 60 can be preloaded for handling compression. The four pieces 50 and wedge insert 60 are well suited for compression.

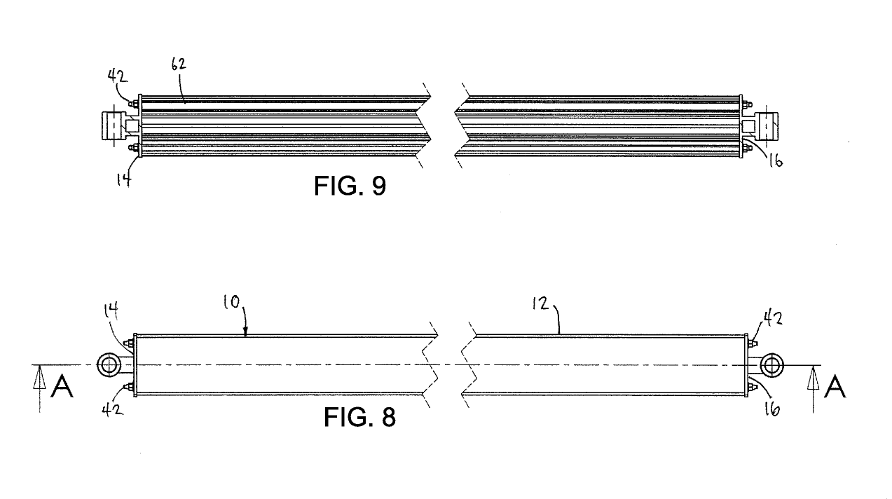

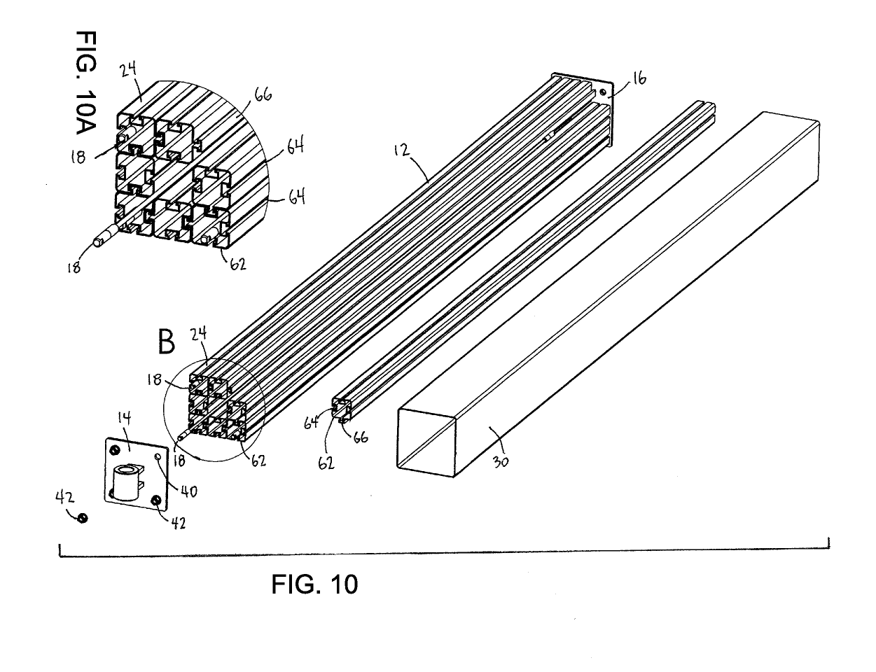

FIGS. 8-10 show a composite structural member 10 with interconnecting pieces 62 that can interconnect to form various shapes of the structural member 10. As shown, interconnecting pieces 62 have a plurality of openings 64 that are able to accept a corresponding attachment 66 of an adjacent piece 62. The preferred interconnecting connectors as shown have three T-shaped slots as openings 64 with a complementary T-shaped ridge that slides into a T-shaped slot as the attachment 66 of an adjacent piece 62. These pieces 62 can be extruded aluminum. The cable 18, such as wire rope, can be preloaded to provide additional safety and stability, such as against buckling and holding end pieces, 14 and 16, together. Four cables 18, one is each corner of the elongated body 12, can be connected to end pieces 14 and 16. Each end piece 14 and 16 may have cable apertures 40 used in conjunction with a means for preloading the cable with tension 42, such as a hex nut as shown, for securing the ends of a cable 18. Pieces 62 forming an elongated body 12 can be inside a cover mantle 30, such as carbon fiber, S glass fiber, a thin swaged layer of steel or Kevlar, on the outer surface 24. The cover mantle 30 can additionally assist with resisting forces of compression and buckling as well as cover any unused opening 64 of the various pieces 62.

For each embodiment, the components can be made of any suitable material. The elongated body 12 is preferably metal, ideally aluminum, but could be made of plastic or other materials. The cable 18 can be a wire rope formed from steel or a fiber rope, and may be cord formed from various materials.

The multipurpose structural member 10 can be adapted for various uses. While functional pieces 38 may dictate uses for the composite structural member 10, the member 10 may be used in a variety of applications as struts, braces, support, props and beams for various structures as tension or compression components. The composite structural member 10 provides benefits for resisting a combination of tension, compression, and buckling forces.

The structural members 10 as aluminum extrusions wrapped in composite fiber are particularly well-suited for a structural load bearing device 70, such as configured as a modular crane, built out of composite components, including structural members 10 and connectors 72, such as T-connectors 73, L-shaped C-connectors 74, and V-connectors as acute angled 75 and obtuse angled 76, such as where a horizontal support member 80 attaches to a jib 82 as a projecting arm. As shown at the base, horizontal composite members 86 can pass through T-connectors 73 and be attached to a vertical composite member 84, or as where the vertical composite member 84 supports the upper horizontal composite members 86 ends of each horizontal composite member 86 could be secured to other structural members.

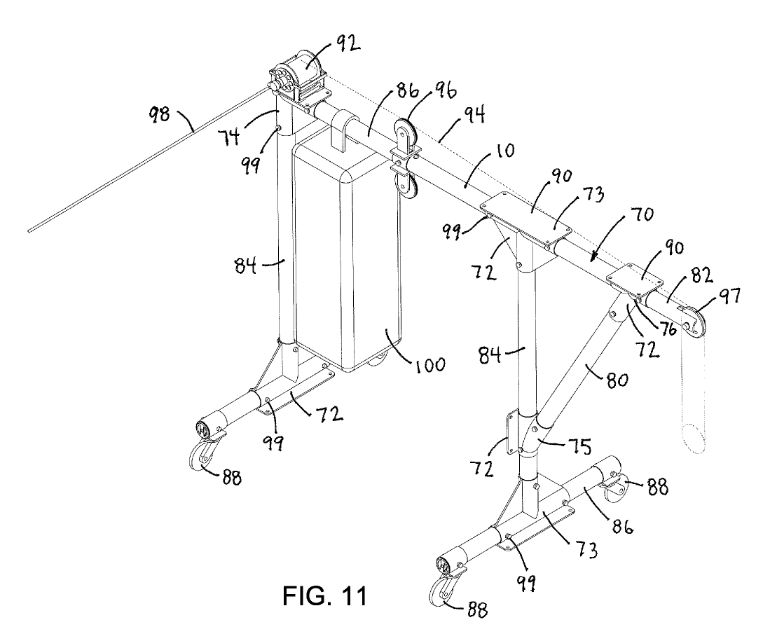

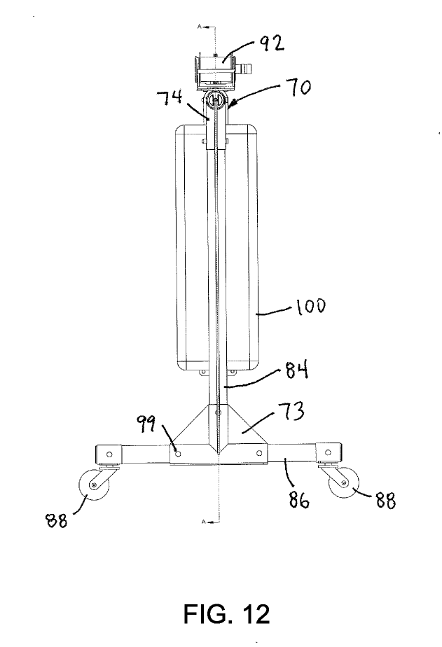

In the example crane of FIGS. 11-13, T-connectors 73 can connect structural members 10 as a vertical composite member 84, a horizontal composite member 86 with a jib 82 or a vertical composite member 84 with a horizontal composite member 86, as shown centered as a base with wheels 88 on each end. The composite structural members 80, 82, 84 and 86 can be assembled and disassembled into different configurations using the plurality of connectors 72-76.

Each connector 72-76 may have a flat portion 90 for added strength, which also may be suitable for various uses, such as mounting a winch 92 (or motor) as shown on the L-shaped C-connector 74. As such, the winch 92 may be adjacent to the sheave 96 or 97 to align the winchrope 94.

The winch 92 has a standard drum on similar component for coiling a winchrope 94 (lifting rope, cable, chain or the like) for pulling or hoisting. As shown, a sheave 96 may be attached on a horizontal composite member 86 as the structural member 10 with the load at the center or a front sheave 97 may be at the end of the jib 82. Either sheave 96 or 97 can be operably coupled with the winchrope 94, such as secured in grooves in a rotatable sheave wheel.

It is contemplated that a wheel 88 could be interchangeable with a front sheave 97 as its grooved wheel to minimize the number of distinct components. As such, the wheel 88 at the end of a horizontal composite member 86 (at the base of the device 70) could duly function as a front sheave 97 at a distal end of a horizontal composite member, jib 82, when used in another configuration.

The elongated body 12 as a composite body is preferably an aluminum extrusion wrapped in a composite fiber, such as an aluminum pipe with an outer diameter of approximately 100 mm and a glass fiber wrap of about 4 mm. Ideally, the outer width, as an outer diameter as shown in FIG. 11-13, would be the same for a plurality of members 80, 82, 84 and 86 to fit into complementary connectors 72-76.

A braided steel wire as cable 18 is preferably inside the structural member 10 to provide safety in the event of a catastrophic failure of structural load bearing configuration. Such cable 18 can be internal to each member as detailed above and/or as safety for the entire load bearing device 70.

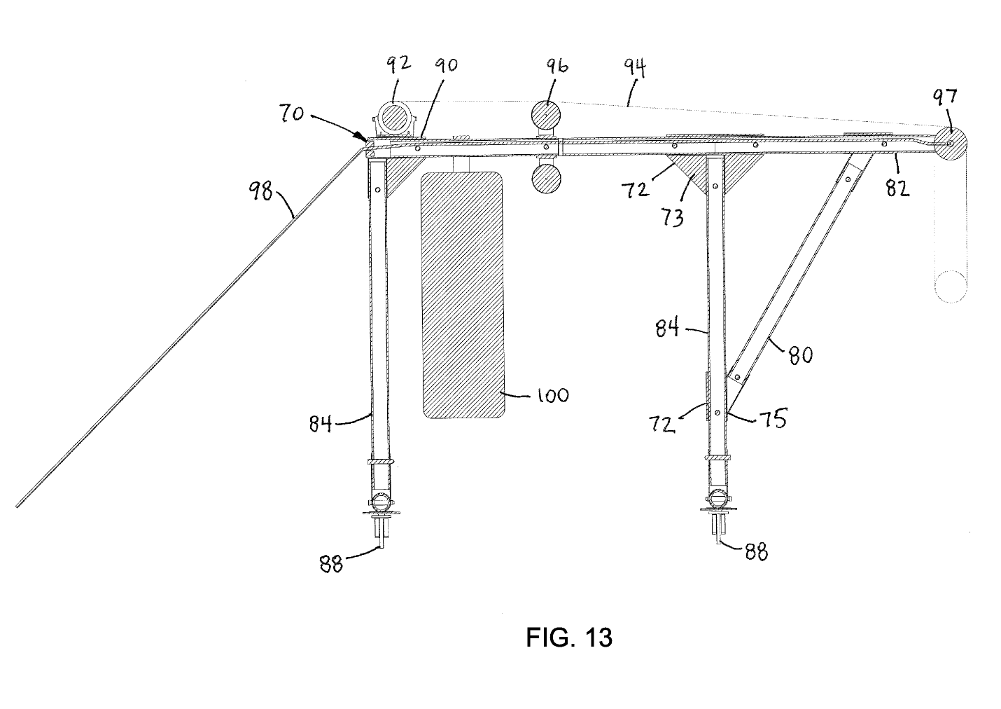

A safety rope 98 (any wire rope, cable, chain or the like) can additionally pass through a jib 82 and a horizontal composite member 86 to be fixed on the ground or similar surface adjacent to the device 70 as a safety rope. The safety rope 98 can be a tensioned cable when fixed at both ends. If used, end pieces, 14 and 16, would have openings to allow the safety rope 98 to completely pass through. The safety rope 98 would ideally attach to the sheave 96 or 97 and pass through an internal recess 20 in the corresponding member to be fixed on the ground, surface of an oil rig, etc. In the cross sectional FIG. 13, the safety rope 98 is fixed on the ground or other external surface at one end and passes through a horizontal composite member 86 and a jib 82 to secure to the front sheave 97.

If end pieces 14 and 16 are used with structural members 10, in this variation, they would have an opening or an aperture for a safety rope 98 in the internal recess 20 to pass through the elongated body 12.

Examples of a structural load bearing configuration include a modular gantry crane as shown in FIGS. 11-13. It may be center loaded on a horizontal composite member 86 or if assembled as such on a front sheave 97 at the end of the jib 82, which is well suited for a compact loading area, such as on a offshore oil rig. But it is contemplated that the members 80, 82, 84 and 86 can be assembled in a variety of load bearing device 70 in modular structures of preassembled or presized units of standard sizes (such as shown with 2000 mm length for vertical composite members 84 and selected horizontal composite members 86, and 1500 mm length for the support member 80 and certain horizontal composite members 86, such as with attached wheels 88.) While shown with two lengths, the load bearing device 70 could be assembled with a single length of members. The width or outer diameter as shown for all members 80, 82, 84 and 86 is preferably the same to all fit into complementary connectors 72-76. The members 80, 82, 84 and 86 can be predrilled with holes for assembly with reusable fasteners 99, such as cotter pins or bolts, to reinforce the connection between members and connectors for easy assembly and disassembly.

The gantry crane can be constructed including structural members 10 preassembled as various members 80, 82 84 and/or 86, preferably having the same width or diameter and connectors 72-76 adapted to accept that common width or diameter of the members. To be readily assembled, disassembled and reassembled, reusable fasteners, such as pins 99, can be used to removably secure structural members 10 to connectors 72-76.

The structural load bearing device 70 may include a fillable counter weight 100, such as attached to or hung from an upper horizontal composite member 86. The type of fillable counter weight can depend on the usage. For example, as shown in FIG. 11, the fillable counter weight is a water blivet as may be used where water is common, such as cranes assembled on offshore oil rigs. Similarly, the fillable counter weight could be a hanging “sandbag” as may be used where sand is common, such as in a desert. When dissembled, the water or sand could be drained or removed to keep components light weight for easy transport or reassembly.

This disclosure has been described as having exemplary embodiments and is intended to cover any variations, uses, or adaptations using its general principles. It is envisioned that those skilled in the art may devise various modifications and equivalents without departing from the spirit and scope of the disclosure as recited in the following claims. Further, this disclosure is intended to cover such variations from the present disclosure as come within the known or customary practice within the art to which it pertains.

We claim:

1. A modular structural load bearing device comprising:
a winch and lifting rope;
a sheave operably coupled to the lifting rope;
a plurality of composite structural members each with an elongated body having an internal recess for a cable; and
a plurality of connectors for connecting the composite structural members,
wherein the composite structural members can be assembled and disassembled into different configurations using the plurality of connectors.

2. The modular structural load bearing device of claim 1 further comprising end pieces on each end of the elongated body; and an internal cable connected to each end piece, the cable passing inside the internal recess; wherein the tensioned cable is fitted between the end pieces wherein the members are preloaded with an internal cable in tension.

3. The modular structural load bearing device of claim 1 wherein the elongated body additionally includes internal spaced walls for added reinforcement, which form part of the internal recess.

4. The modular structural load bearing device of claim 1 wherein each elongated body is formed from extruded aluminum with a composite fiber covering.

5. The modular structural load bearing device of claim 1 wherein the elongated body has a plurality of internal recesses for a plurality of cables.

6. The modular structural load bearing device of claim 5 wherein a safety rope connects the sheave via the internal recess in at least one elongated body then passing outside the load bearing device to attach to a separate external surface.

7. The modular structural load bearing device of claim 2 wherein the end pieces have an opening or an aperture for a safety rope in the internal recess to pass through the elongated body.

8. The modular structural load bearing device of claim 1 wherein the modular structural load bearing device is a gantry crane constructed from preassembled members having the same width or diameter and connectors adapted to accept that common width or diameter and includes reusable fasteners to removably secure members to connectors.

9. The modular structural load bearing device of claim 1 wherein the connectors include a flat portion and the winch is mounted on one of the flat portions and is adjacent to the sheave for aligning the lifting rope.

10. The modular structural load bearing device of claim 1 further comprising a fillable counterweight attached to one horizontal composite structural member.

11. A modular structural load bearing device comprising:
a plurality of light-weight structural members wrapped in composite fiber each with an elongated body having internal walls forming part of an internal recess;
a plurality of connectors securing a portion of each structural member to another structural member, each connector including a flat surface;
a winch with a lifting rope, the winch mounted on the flat surface of one connector;
a sheave operably coupled to the lifting rope; the sheave connected on one of the structural members;
a tensioned cable passing inside at least one internal recess; wherein the tensioned cable is fitted between the sheave and a fixed point adjacent to the load bearing device.

12. The modular structural load bearing device of claim 11 further comprising a fillable counterweight attached to a horizontal composite member that is one of the structural members.

13. The modular structural load bearing device of claim 11 wherein the ends of horizontal composite members have an opening or an aperture for the tensioned cable to pass through at least one horizontal composite member to act as a safety in case of catastrophic failure of the device's components.

14. The modular structural load bearing device of claim 11 further comprising a second sheave mounted on a horizontal structural member that is one of the structural members between two connectors to vertical structural members.

15. A modular crane assembled from presized complementary components including:
a plurality of support members having an elongated body having a first end, a second end, and an internal recess for a cable extending from the first end to the second end of the body;
a cable located within one of the recesses of the body, the cable having a first end and a second end, the first end of the cable being coupled to a sheave; the second end of the cable fixable to nearby fixed point to provide a safety rope;
a series of presized connectors adapted to accept the support members to secure the support members together;
a winch mountable on a connector, the winch having a lifting rope,
wherein the support members form vertical support members and horizontal support members including a horizontal dimension for the winch and a sheave and another horizontal dimension for wheels to roll on the ground with the horizontal dimensions connected via the connectors to vertical support members.

16. The modular crane of claim 15 wherein each body includes a plurality of internal recesses for one or more cables.

17. The modular crane of claim 15 further including a counter weight fillable with water or sand.

18. The modular crane of claim 15 wherein the sheave extends from a distal end of a horizontal support member extending outward from a connection with a vertical support member.

19. The modular crane of claim 15 wherein the plurality of support members include support members of the same outer width and of only one or two lengths and further including a series of pins for easy assembly and disassembly.

20. The modular crane of claim 15 wherein the wheel at an end of the horizontal support member as used at the base of the crane could be interchangeable as the front sheave at an end of the horizontal support member when used in conjunction with the lifting rope to minimize the number of distinct components.
